(19) United States
(12) Patent Application Publication
(10) Pub. No.: US 2025/0332754 A1
(43) Pub. Date: Oct. 30, 2025

(54) TABLE SAW SAFETY DEVICE

(71) Applicant: Christopher Sekeres, Washington, PA (US)

(72) Inventor: Christopher Sekeres, Washington, PA (US)

(21) Appl. No.: 19/054,974

(22) Filed: Feb. 17, 2025

Related U.S. Application Data
(60) Provisional application No. 63/637,919, filed on Apr. 24, 2024.

(51) Int. Cl. B27G 19/02; B27G 13/08; B27G 19/08

(52) U.S. Cl. CPC B27G 19/028; B27G 13/08; B27G 19/025; B27G 19/08

(57) ABSTRACT

A table saw safety device is disclosed, which mounts from above, enhancing safety when using dado blades. The table saw safety device comprises an arm component that supports a pair of large anti-kickback components positioned above the blade, allowing workpieces to be safely maneuvered over the dado blade while maintaining high clearance. This setup not only facilitates safe completion of cuts but also ensures the user remains clear of the operational zone. The arm component attaches securely to the table saw's side and is compatible with both existing saws and new installations. The device is also comprised of an adjustable riving knife integrated into the throat plate, a clear guard with adjustable width, and a flexible boom accommodating different table sizes.

### CROSS-REFERENCE TO RELATED APPLICATION

The present application claims priority to, and the benefit of, U.S. Provisional Application No. 63/637,919, which was filed on Apr. 24, 2024, and is incorporated herein by reference in its entirety.

### FIELD OF THE INVENTION

The present invention relates generally to the field of table saw safety devices. More specifically, the present invention relates to an improved table saw safety device that provides a kickback guard that can be used with a dado blade. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in table saw safety devices. Generally, conventional table saws necessitate the removal of the guard and riving knife for dado blade use, posing significant safety risks.

Accordingly, the design of ordinary table saws has the safety device mounted from behind the table saw. Thus, a user is required to take off the guard and riving knife when using a dado blade, making them incredibly unsafe. However, dado blades can be useful in woodworking, requiring users to forego the risks to use the dado blade.

Accordingly, there is a demand for an improved table saw safety device that allows users to use the dado blade without removal of a saw guard. More particularly, there is a demand for a table saw safety device that provides larger anti-kickback components mounted above the blade and an adjustable riving knife built into the throat plate.

Therefore, there exists a long felt need in the art for a table saw safety device that provides users with a table saw kickback guard that can be used with a dado blade. There is also a long felt need in the art for a table saw safety device that has an adjustable riving knife built into the throat plate. Further, there is a long felt need in the art for a table saw safety device that has a clear guard with adjustable width. Moreover, there is a long felt need in the art for a device that has an adjustable boom for different table sizes. Further, there is a long felt need in the art for a table saw safety device that utilizes an arm that is secured to the side of a table saw table. Finally, there is a long felt need in the art for a table saw safety device that provides higher clearance for the guide bar used for cuts.

The subject matter disclosed and claimed herein, in one embodiment thereof, comprises a table saw safety device. The device is a table saw safety device that mounts from above, enhancing safety when using dado blades. The table saw safety device comprises an arm component that supports a pair of large anti-kickback components positioned above the blade, allowing workpieces to be safely maneuvered over the dado blade while maintaining high clearance. This setup not only facilitates safe completion of cuts but also ensures the user remains clear of the operational zone. The arm component attaches securely to the table saw's side and is compatible with both existing saws and new installations. The device is also comprised of an adjustable riving knife integrated into the throat plate, a clear guard with adjustable width, and a flexible boom accommodating different table sizes.

In this manner, the table saw safety device of the present invention accomplishes all of the forgoing objectives and provides users with a device that allows for the safe use of dado blades. The device mounts from above instead of behind to allow for a higher clearance when performing cuts. The device can comprise a removable design allowing for the exchange of blades.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a table saw safety device. The device is a table saw safety device that mounts from above, enhancing safety when using dado blades. The table saw safety device comprises an arm component that supports a pair of large anti-kickback components positioned above the blade, allowing workpieces to be safely maneuvered over the dado blade while maintaining high clearance. This setup not only facilitates safe completion of cuts but also ensures the user remains clear of the operational zone. The arm component attaches securely to the table saw table's side and is compatible with both existing saws and new installations. The device is also comprised of an adjustable riving knife integrated into the throat plate, a clear guard with adjustable width, and a flexible boom accommodating different table sizes.

In one embodiment, the table saw safety device mounts from above instead of behind to allow for the safe use of dado blades. Accordingly, the design of ordinary table saws requires taking off the safety guard and riving knife when using a dado blade, making them incredibly unsafe. The table saw safety device features an arm component that mounts larger anti-kickback components above the dado blade, enabling pieces to be safely passed over the dado blade. Further, the device has higher clearance and offers the room to safely finish cuts while keeping users out of the way of the work. The device is designed to securely fasten onto the side of the table saw table and can be easily added to existing table saws or included in new setups.

In one embodiment, the table saw safety device is a conventional table saw integrated within a table. The table saw safety device utilizes a dado blade, but can be used with any other suitable blades as is known in the art. A dado blade is a type of circular saw blade used on table saws to cut a wider groove in material, usually wood, wider than a traditional saw blade would. The table saw safety device can be utilized with any suitable size of dado blade as is known in the art.

In one embodiment, the table saw safety device comprises a table saw which includes a blade assembly mounted on a base in manner so that the saw blade extends through a slot defined in the work surface of the base. Further, the blade assembly includes an undercarriage assembly that supports the saw blade beneath the work surface and permits variable positions of the saw blade relative to the work surface, such as variable heights and angles. Typically, the base is supported by a plurality of legs to form the table. The legs allow for the base to be supported at a variety of different heights, depending on the needs and/or wants of a user.

In one embodiment, the table saw is provided with a power train that is coupled between the saw blade and a drive motor to rotate the saw blade during use. Typically, the table saw is powered electrically via a power cord plugged into a conventional wall outlet.

In one embodiment, the table saw safety device comprises an arm component that attaches securely to the table saw table's side and is compatible with both existing saws and new installations. Specifically, the arm component is securely fastened to a side of the table base via welding, pins, screws, etc. In one embodiment, the arm component is releasably secured to the table base, such that the arm component includes an arm release button that once pressed, releases the arm component and allows for quick removal.

In one embodiment, the arm component comprises an adjustable boom for different table sizes. The adjustable boom can be telescoped in and out, depending on the width of the table containing the table saw. Further, the arm component can be any suitable shape and size as is known in the art. Also, the arm component provides safer overhead mounting, instead of being mounted behind, which allows for safe use of the dado blades, while maintaining high clearance for the work pieces being maneuvered over the dado blade.

In one embodiment, the arm component supports a pair of large anti-kickback components positioned above the blade, allowing workpieces to be safely maneuvered over the dado blade while maintaining high clearance. This setup not only facilitates safe completion of cuts but also ensures the user remains clear of the operational zone. Specifically, the pair of anti-kickback components are secured to opposing sides of a clear plastic guard. The clear plastic guard is sized and shaped to encompass the saw blade and through slot to protect the user. The clear plastic guard is then secured to an overhead attachment column secured on the arm component. In operation, the opposing sides are positioned to slide back and forth across the work surface and the front and back of the guard remains open. Further, the guard has an adjustable width and can be positioned at various desired widths, depending on the size of the dado blade being used and/or the size of the work pieces.

In one embodiment, the pair of large anti-kickback components are secured directly to the plastic guard, one on each opposing side. The pair of large anti-kickback components can be secured via pins, screws, adhesive, glue, etc. Further, the anti-kickback components can be any suitable shape and size as is known in the art, such as a curved shape with a plurality of teeth at an edge to grip the work piece, during use. The anti-kickback components are mounted over the saw blade, enabling work pieces to be safely passed over the dado blade. Thus, the anti-kickback components are mounted at a higher clearance, which offers room to safely finish cuts while keeping users out of the way of the work.

In one embodiment, the device comprises an adjustable riving knife integrated into the throat plate of the slot in the work surface. The riving knife can be adjusted up and down, as well as side to side, as needed. Since the riving knife is adjustable, it doesn't have to be removed when using the dado blade as in prior art saws. Thus, users can work more efficiently when using the dado blade with the disclosed device and adjustable riving knife.

In one embodiment, the table saw safety device can be removed, as needed and applied to other table saws, or stored. The removable design of the device, allows for the exchange of blades, etc.

In yet another embodiment, the table saw safety device comprises a plurality of indicia.

In yet another embodiment, a method of utilizing a dado blade with a safety anti-kickback component is disclosed. The method includes the steps of providing a table saw safety device comprising an arm component that supports a pair of anti-kickback components. The method also comprises adjusting the boom of the arm component to a desired table size. Further, the method comprises securing the anti-kickback components to a plastic guard. The method also comprises adjusting the width of the plastic guard. The method comprises adjusting the riving knife integrated into the throat plate. Finally, the method comprises cutting with a dado blade while ensuring a user's safety.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the table saw safety device of the present invention showing the arm component secured to a table saw in accordance with the disclosed architecture;

FIG. 2 illustrates a perspective view of one embodiment of the table saw safety device of the present invention showing the adjustable boom of the arm component in accordance with the disclosed architecture;

FIG. 3 illustrates a perspective view of one embodiment of the table saw safety device of the present invention showing the pair of anti-kickback components in accordance with the disclosed architecture;

FIG. 4 illustrates a perspective view of one embodiment of the table saw safety device of the present invention showing the adjustable riving knife in accordance with the disclosed architecture;

FIGS. 5A, 5B and 5C illustrate a perspective view of one embodiment of the table saw safety device of the present invention showing the clear guard in accordance with the disclosed architecture;

FIGS. 6A, 6B, and 6C illustrate a perspective view of one embodiment of the table saw safety device of the present invention showing the device in use in accordance with the disclosed architecture; and

FIG. 7 illustrates a flowchart showing the method of utilizing a dado blade with a safety anti-kickback component in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a table saw safety device that provides users with a table saw kickback guard that can be used with a dado blade. There is also a long felt need in the art for a table saw safety device that has an adjustable riving knife built into the throat plate. Further, there is a long felt need in the art for a table saw safety device that has a clear guard with adjustable width. Moreover, there is a long felt need in the art for a device that has an adjustable boom for different table sizes. Further, there is a long felt need in the art for a table saw safety device that utilizes an arm that is secured to the side of a table saw table. Finally, there is a long felt need in the art for a table saw safety device that provides higher clearance for the guide bar used for cuts.

The present invention, in one exemplary embodiment, is a novel table saw safety device. The device is a table saw safety device that mounts from above, enhancing safety when using dado blades. The table saw safety device comprises an arm component that supports a pair of large anti-kickback components positioned above the blade. The arm component attaches securely to the table saw's side and is compatible with both existing saws and new installations. The device is also comprised of an adjustable riving knife integrated into the throat plate, a clear guard with adjustable width, and a flexible boom accommodating different table sizes. The present invention also includes a novel method of utilizing a dado blade with a safety anti-kickback component. The method includes the steps of providing a table saw safety device comprising an arm component that supports a pair of anti-kickback components. The method also comprises adjusting the boom of the arm component to a desired table size. Further, the method comprises securing the anti-kickback components to a plastic guard. The method also comprises adjusting the width of the plastic guard. The method comprises adjusting the riving knife integrated into the throat plate. Finally, the method comprises cutting with a dado blade while ensuring a user's safety.

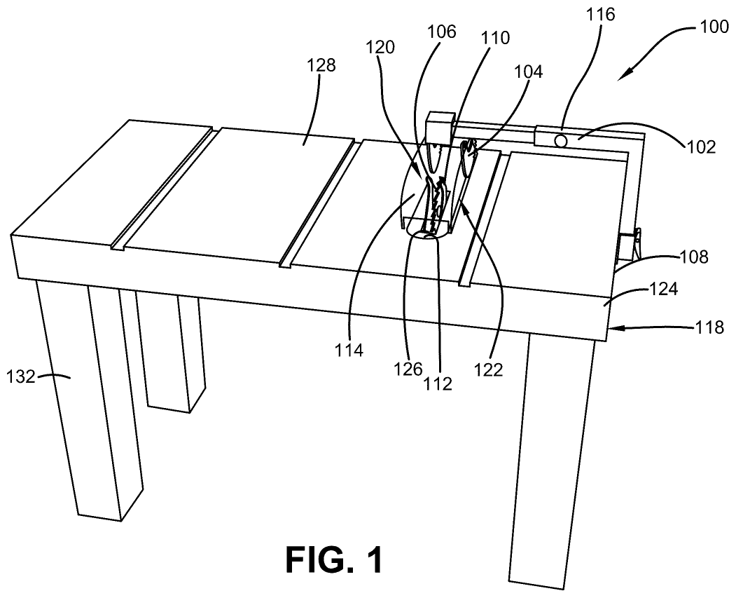

Referring initially to the drawings, FIG. 1 illustrates a perspective view of one embodiment of the table saw safety device 100 of the present invention. In the present embodiment, the table saw safety device 100 is an improved table saw safety device 100 that provides a user with an enhanced safety saw when using dado blades. Specifically, the table saw safety device 100 comprises an arm component 102 that supports a pair of large anti-kickback components 104 positioned above the dado blade 106. This setup not only facilitates safe completion of cuts but also ensures the user remains clear of the operational zone. The arm component 102 attaches securely to the table saw table's side 108 and is compatible with both existing saws and new installations. The device 100 is also comprised of an adjustable riving knife 110 integrated into the throat plate 112, a clear guard 114 with adjustable width, and a flexible boom 116 accommodating different table 118 sizes.

Further, the table saw safety device 100 mounts from above instead of behind to allow for the safe use of dado blades 106. Accordingly, the design of ordinary table saws requires taking off the safety guard and riving knife when using a dado blade 106, making them incredibly unsafe. The table saw safety device 100 features an arm component 102 that mounts larger anti-kickback components 104 above the dado blade 106, enabling pieces to be safely passed over the dado blade 106. Further, the device 100 has higher clearance and offers the room to safely finish cuts while keeping users out of the way of the work. The device 100 is designed to securely fasten onto the side 108 of the table saw table 118 and can be easily added to existing table saws or included in new setups.

Generally, the table saw safety device 100 is a conventional table saw 120 integrated within a table 118. The table saw safety device 100 utilizes a dado blade 106, but can be used with any other suitable blades as is known in the art. A dado blade 106 is a type of circular saw blade used on table saws to cut a wider groove in material, usually wood, wider than a traditional saw blade would. The table saw safety device 100 can be utilized with any suitable size of dado blade 106 as is known in the art.

Furthermore, the table saw safety device 100 comprises a table saw 120 which includes a blade assembly 122 mounted on a base 124 in a manner so that the saw blade 106 extends through a slot 126 defined in the work surface 128 of the base 124. Further, the blade assembly 122 includes an undercarriage assembly 130 that supports the saw blade 106 beneath the work surface 128 and permits variable positions of the saw blade 106 relative to the work surface 128, such as variable heights and angles. Typically, the base 124 is supported by a plurality of legs 132 to form the table 118. The legs 132 allow for the base 124 to be supported at a variety of different heights, depending on the needs and/or wants of a user.

Additionally, in one embodiment, the table saw 120 is provided with a power train 134 that is coupled between the saw blade 106 and a drive motor 136 to rotate the saw blade 106 during use. Typically, the table saw 120 is powered electrically via a power cord (not shown) plugged into a conventional wall outlet, but can be powered via any suitable means as is known in the art.

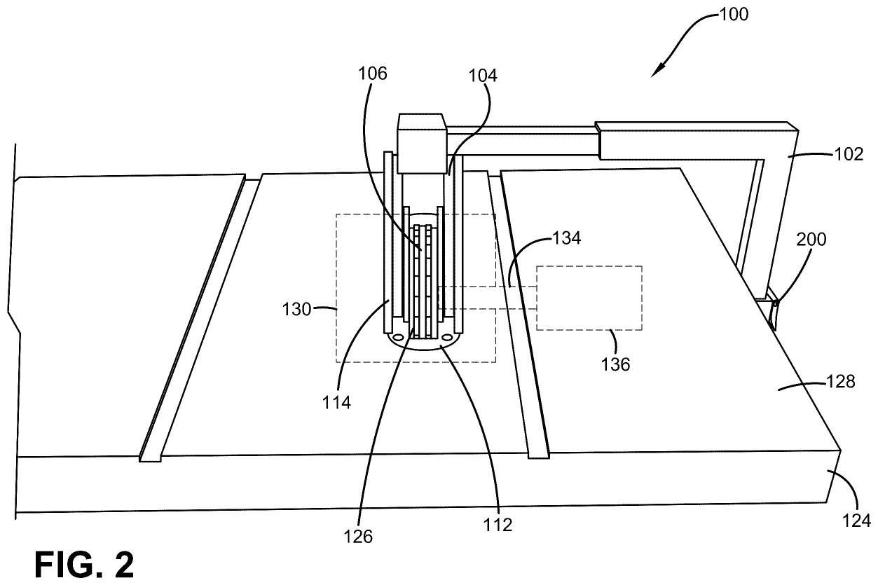

As shown in FIG. 2, the table saw safety device 100 comprises an arm component 102 that attaches securely to the table saw table's side 108 and is compatible with both existing saws and new installations. Specifically, the arm component 102 is securely fastened to a side 108 of the table base 124 via welding, pins, screws, etc. In one embodiment, the arm component 102 is releasably secured to the table base 124, such that the arm component 102 includes an arm release button 200 that once pressed, releases the arm component 102 and allows for quick removal.

Further, the arm component 102 comprises an adjustable boom 116 for different table sizes. The adjustable boom 116 can be telescoped in and out, depending on the width of the table 118 containing the table saw 120. Further, the arm component 102 can be any suitable shape and size as is known in the art. Also, the arm component 102 provides safer overhead mounting, instead of being mounted behind, which allows for safe use of the dado blades 106, while maintaining high clearance for the work pieces being maneuvered over the dado blade 106.

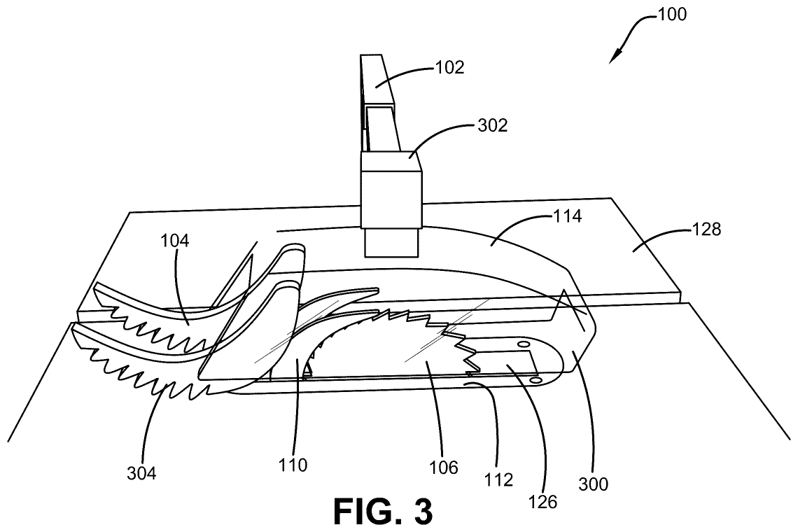

As shown in FIG. 3, the arm component 102 supports a pair of large anti-kickback components 104 positioned above the blade 106, allowing workpieces to be safely maneuvered over the dado blade 106 while maintaining high clearance. This setup not only facilitates safe completion of cuts but also ensures the user remains clear of the operational zone. Specifically, the pair of anti-kickback components 104 are secured to opposing sides 300 of a clear plastic guard 114. The clear plastic guard 114 is sized and shaped to encompass the saw blade 106 and through slot 126 to protect the user. The clear plastic guard 114 is then secured to an overhead attachment column 302 secured on the arm component 102. In operation, the opposing sides 300 are positioned to slide back and forth across the work surface 128 and the front and back of the guard 114 remains open. Further, the guard 114 has an adjustable width and can be positioned at various desired widths, depending on the size of the dado blade 106 being used and/or the size of the work pieces.

Further, the pair of large anti-kickback components 104 are secured directly to the plastic guard 114, one on each opposing side 300. The pair of large anti-kickback components 104 can be secured via pins, screws, adhesive, glue, etc. Further, the anti-kickback components 104 can be any suitable shape and size as is known in the art, such as a curved shape with a plurality of teeth 304 at an edge to grip the work piece, during use. The anti-kickback components 104 are mounted over the saw blade 106, enabling work pieces to be safely passed over the dado blade 106. Thus, the anti-kickback components 104 are mounted at a higher clearance, which offers room to safely finish cuts while keeping users out of the way of the work.

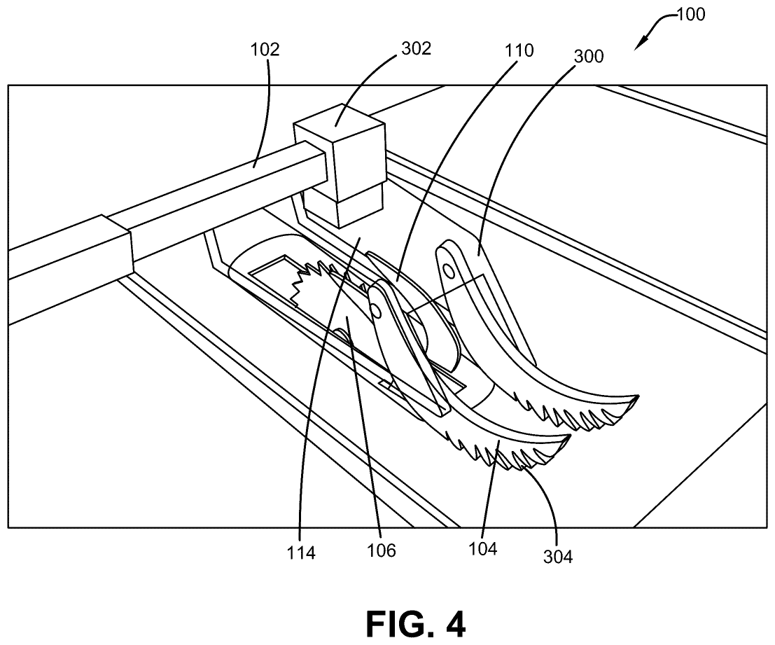

As shown in FIG. 4, the device 100 comprises an adjustable riving knife 110 integrated into the throat plate 112 of the slot 126 in the work surface 128. The riving knife 110 can be adjusted up and down, as well as side to side, as needed. Since the riving knife 110 is adjustable, it doesn't have to be removed when using the dado blade 106 as in prior art saws. Thus, users can work more efficiently when using the dado blade 106 with the disclosed device 100 and adjustable riving knife 110.

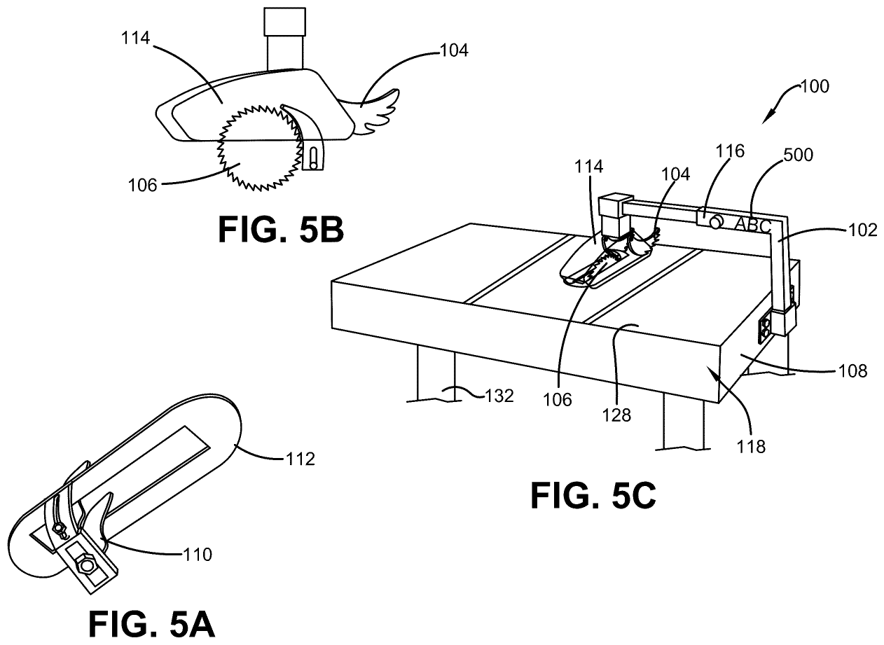

As shown in FIGS. 5A-C, the table saw safety device 100 can be removed, as needed and applied to other table saws, or stored. The removable design of the device 100, allows for the exchange of blades, etc.

In yet another embodiment, the table saw safety device 100 comprises a plurality of indicia 500. The arm component 102 of the device 100 may include advertising, a trademark, or other letters, designs, or characters, printed, painted, stamped, or integrated into the arm component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be table saw, dado blade, or brand related.

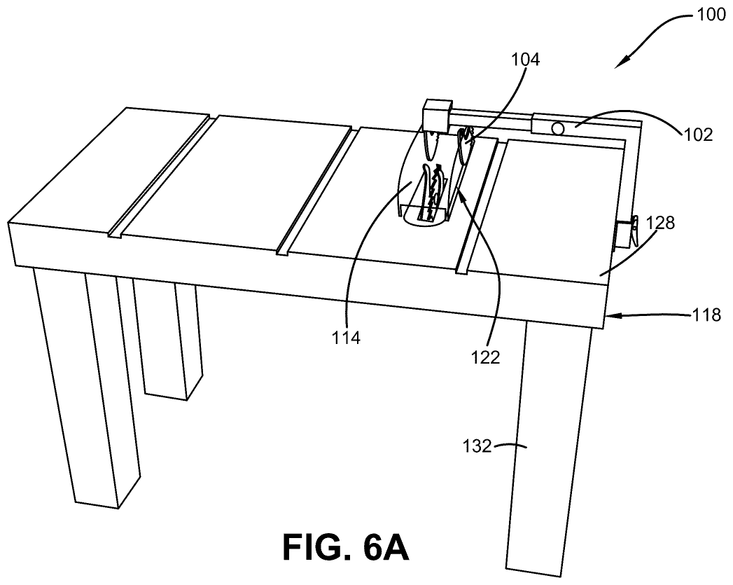

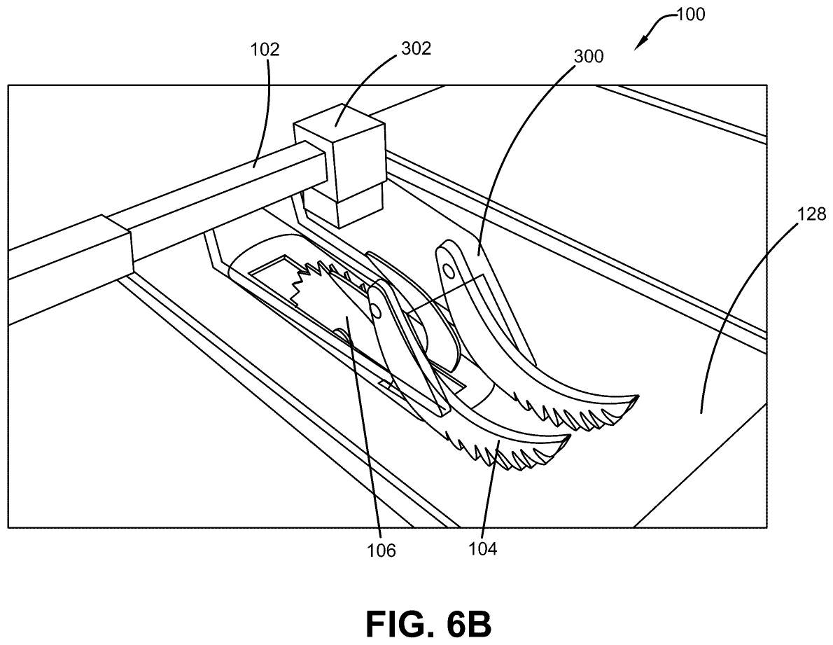

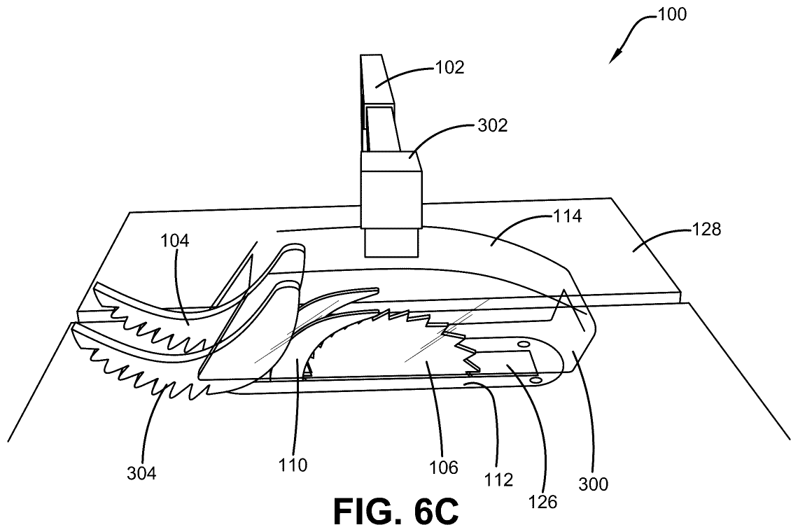

As shown in FIGS. 6A-C, in operation, the table saw safety device 100 mounts from above instead of behind to allow for the safe use of dado blades 106. Accordingly, the arm component 102 is secured to the side 108 of the table 118 and the flexible boom 116 is adjusted to the table's width. The clear guard 114 is secured to the arm component 102 and the pair of anti-kickback components 104 are secured to the clear guard 114. Thus, the table saw safety device 100 positions the larger anti-kickback components 104 above the dado blade 106, enabling pieces to be safely passed over the dado blade 106. Further, the device 100 has higher clearance and offers the room to safely finish cuts while keeping users out of the way of the work. The adjustable riving knife 110 allows for adjustability when using the dado blade 106.

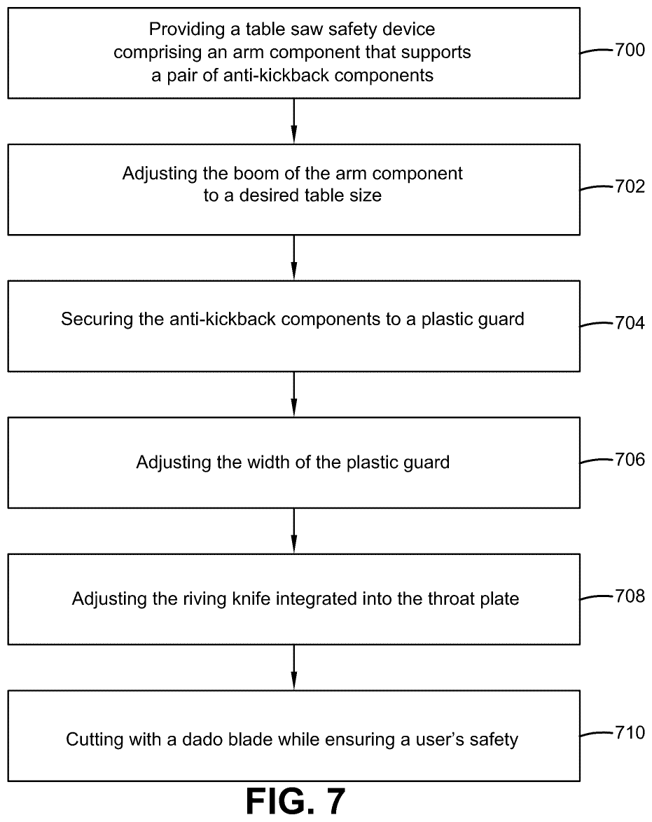

FIG. 7 illustrates a flowchart of the method of utilizing a dado blade with a safety anti-kickback component. The method includes the steps of at 700, providing a table saw safety device comprising an arm component that supports a pair of anti-kickback components. The method also comprises at 702, adjusting the boom of the arm component to a desired table size. Further, the method comprises at 704, securing the anti-kickback components to a plastic guard. The method also comprises at 706, adjusting the width of the plastic guard. The method comprises at 708, adjusting the riving knife integrated into the throat plate. Finally, the method comprises at 710, cutting with a dado blade while ensuring a user's safety.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “table saw safety device”, “table saw device”, “safety device”, and “device” are interchangeable and refer to the table saw safety device 100 of the present invention.

Notwithstanding the forgoing, the table saw safety device 100 of the present invention can be of any suitable size and configuration as is known in the art without affecting the overall concept of the invention, provided that it accomplishes the above stated objectives. One of ordinary skill in the art will appreciate that the table saw safety device 100 as shown in FIGS. 1-7 is for illustrative purposes only, and that many other sizes and shapes of the table saw safety device 100 are well within the scope of the present disclosure. Although the dimensions of the table saw safety device 100 are important design parameters for user convenience, the table saw safety device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A table saw safety device that provides a user with an enhanced safety saw when using dado blades, the table saw safety device comprising:
an arm component; and
a pair of anti-kickback components;
wherein the arm component is secured to a side of a table with an integrated table saw;
wherein the arm component supports the pair of anti-kickback components positioned above a dado blade of the integrated table saw; and
further wherein having the pair of anti-kickback components positioned above the dado blade facilitates safe completion of cuts and ensures a user remains clear of operational zone.

2. The table saw safety device of claim 1, wherein the integrated table saw includes a blade assembly mounted on a base in a manner so that the dado blade extends through a slot defined in a work surface of the base.

3. The table saw safety device of claim 2, wherein the blade assembly includes an undercarriage assembly that supports the dado blade beneath the work surface and permits variable positions of the dado blade relative to the work surface, such as variable heights and angles.

4. The table saw safety device of claim 3, wherein the base is supported by a plurality of legs to form the table.

5. The table saw safety device of claim 4 wherein the table saw is provided with a power train that is coupled between the dado blade and a drive motor to rotate the dado blade during use.

6. The table saw safety device of claim 5, wherein the arm component attaches securely to the table's side and is compatible with both existing saws and new installations.

7. The table saw safety device of claim 6, wherein the arm component is releasably secured to the base, such that the arm component includes an arm release button that once pressed, releases the arm component and allows for quick removal.

8. The table saw safety device of claim 7, wherein the arm component comprises an adjustable boom for different table sizes, that can be telescoped in and out, depending on a width of the table containing the table saw.

9. The table saw safety device of claim 8, wherein the pair of anti-kickback components are secured to opposing sides of a clear plastic guard.

10. The table saw safety device of claim 9, wherein the clear plastic guard is then secured to an overhead attachment column secured on the arm component.

11. The table saw safety device of claim 10, wherein the clear plastic guard has an adjustable width.

12. The table saw safety device of claim 11, wherein the pair of anti-kickback components have a curved shape with a plurality of teeth at an edge.

13. The table saw safety device of claim 12 further comprising an adjustable riving knife integrated into a throat plate of the slot in the work surface.

14. A table saw safety device that provides a user with an enhanced safety saw when using dado blades, the table saw safety device comprising:
an arm component that attaches securely to a table's side and is compatible with both existing saws and new installations; and
a pair of anti-kickback components secured to opposing sides of a clear plastic guard; and
wherein the integrated table saw includes a blade assembly mounted on a base in a manner so that the dado blade extends through a slot defined in a work surface of the base;
wherein the base is supported by a plurality of legs to form the table;
wherein the table saw is provided with a power train that is coupled between the dado blade and a drive motor to rotate the dado blade during use;
wherein the arm component comprises an adjustable boom for different table sizes, that can be telescoped in and out, depending on a width of the table containing the table saw;
wherein the arm component supports the pair of anti-kickback components positioned above a dado blade of the integrated table saw;
wherein the pair of anti-kickback components have a curved shape with a plurality of teeth at an edge;
wherein the clear plastic guard has an adjustable width; and
further wherein having the pair of anti-kickback components positioned above the dado blade facilitates safe completion of cuts and ensures a user remains clear of operational zone.

15. The table saw safety device of claim 14, wherein the arm component is releasably secured to the base, such that the arm component includes an arm release button that once pressed, releases the arm component and allows for quick removal.

16. The table saw safety device of claim 14 further comprising an adjustable riving knife integrated into a throat plate of the slot in the work surface.

17. The table saw safety device of claim 14, wherein the table saw safety device can be removed, as needed and applied to other table saws, or stored.

18. The table saw safety device of claim 17, wherein the table saw safety device is removable to allow for exchange of dado blades.

19. The table saw safety device of claim 14 further comprising a plurality of indicia.

20. A method of utilizing a dado blade with a safety anti-kickback component, the method comprising the following steps:
providing a table saw safety device comprising an arm component that supports a pair of anti-kickback components;
adjusting the boom of the arm component to a desired table size;
securing the anti-kickback components to a plastic guard;
adjusting the width of the plastic guard;
adjusting the riving knife integrated into the throat plate; and
cutting with a dado blade while ensuring a user's safety.
